(19) United States
(12) Patent Application Publication
(10) Pub. No.: US 2014/0303998 A1
(43) Pub. Date: Oct. 9, 2014

(54) METHOD FOR MANAGING A HEALTH CARD

(71) Applicant: MEDIXINE OY, Espoo (FI)

(72) Inventor: Tapio Jokinen, Espoo (FI)

(73) Assignee: MEDIXINE OY, Espoo (FI)

(21) Appl. No.: 14/353,853

(22) PCT Filed: Oct. 24, 2012
(86) PCT No.: PCT/FI2012/051023

§ 371 Date: Apr. 24, 2014

(30) Foreign Application Priority Data
Oct. 24, 2011 (FI) 20116047

(51) Int. Cl. G06F 19/00; G06Q 50/22; G06Q 10/00; G06F 21/62

(52) U.S. Cl. CPC G06F 19/322; G06F 21/6245; G06F 21/6254; G06Q 50/22; G06Q 10/00
USPC 705/2

(57) ABSTRACT

A system includes an intermediate element, which is provided between a health file copy and at least one party with a strong authentication requiring, and for which a user is identified with some strong identification, and after which the intermediate element associates an intra-health card user identifier and a user identifying code with each other. From the database to the intermediate element is delivered information, which matches the user identifying code and requires strong authentication, whereby the intermediate element for its part delivers at least some of this particular information to such a health card with whose internal identifier the user identifying code has been associated by the intermediate element.

The invention relates to a method and system for managing a health card, as well as to an electronic health card (health file copy). Specifically, the invention relates to a method and system for managing an electronic health card and health card- related communications between at least two parties.

### PRIOR ART

The prior art discloses a variety of solutions for managing communications between an electronic health card, or its counterpart electronic record, and some operator. There are for example solutions that can be categorized at least to some extent as electronic health cards, wherein the solution comprises health information about the user. Health cards of this category may comprise for example information with a weak encryption and authentication requiring, such as age, height, weight, body fat percentage, and athletic achievements. Typically, the encryption requirements for such health cards are quite low and the user is able to log in for example under an anonymous user identity or password. Such health cards can be used for example in services focused on motivating a plurality of users, wherein the users under the protection of anonymity may keep track of and compare their personal records with those of other group members, or even compete with each other for example in weight management or smoking cessation or the like. In addition, there are services dealing with highly personal user information, such as the user's medical records, and requiring strong authentication. The strong authentication can be for example VETUMA (the online identification and payment service (Vetuma) enables a citizen to identify him/herself electronically in all social and business services that the service is linked with). It is natural that such information, which requires strong authentication, cannot be accessed with just an anonymous identifier.

In some situations, however, there are demands that the user's personal information with a strong authentication requiring could be used for example in services targeted at the motivation of users for rendering at least some of the information visible also for others, for example for members of one specific group in need of motivation. It is nevertheless obvious that in such situations the user's personal information with a strong authentication requiring cannot as such be displayed in a way that would enable its association with the true identity of a user. It is because of strict data protection regulations that situations should be avoided in which there would be even a chance in the aforesaid type of services for said personal information with a strong authentication demanding to become associable in wrong hands with the user's true identity.

### SUMMARY

It is one objective of the invention to eliminate or at least reduce drawbacks involved in the prior art. According to one embodiment, the invention seeks to provide such a solution that would enable personal user information with a strong encryption and authentication requiring to be employed for example in services aimed at motivating users for rendering at least some of the information visible also for others, for example for members of one specific same group in need of motivation, yet in such a way that the information with a strong encryption or authentication requiring would not be associable with the user's true identity.

Certain objectives of the invention are achieved by the method of claim 1 and by the system of claim 9.

The method of the invention is characterized by what is presented in claim 1 directed to a method. In addition, the system of the invention is characterized by what is presented in claim 9 directed to a system.

According to a first embodiment, the invention for managing an electronic health card and health card-related communications between at least two parties comprises providing an electronic health card, at least one of said parties comprising or managing a database which is strongly encrypted or requires strong authentication. According to one example, requiring strong authentication refers to the fact that, in order to access said information, a user is required to produce strong identification by means of which the user is identifiable and individualizable unambiguously, i.e. in such a way that the user's true identity can be verified. The health card is most preferably provided with an intra-health card user identifier, which can be for example an anonymous identifier such as #Peter72. According to the invention, between the health card and the strongly encrypted database of at least one party is provided an intermediate means, which is in data transfer communication with both said health card and the party's strongly encrypted or strong authentication requiring database either directly or by way of some element of said party.

According to one embodiment of the invention, the intermediate means is supplied with information about the intra-health card user identifier (e.g. #Peter72). In addition to this, the user is identified for the intermediate means with some strong identification, such as for example by means of a per se known online identification and payment service (VETUMA). After a successful identification, the intermediate means associates with each other said intra-health card user identifier and a user identifying code supplied in connection with strong identification. The user identifying code is any code of the type that enables said user to be identified individually and reliably. Such a code is for example a social security number, but it may also be some other user specifying code.

The system comprises transmission of data between a health card and a strongly encrypted or strong authentication requiring database of at least one party, said database being supplied by the at least one party with said information that requires strong encryption or authentication. The information is associable in said database with said user identifying code.

According to one embodiment of the invention, the intermediate means is supplied from said strongly encrypted database with such information that can be associated in said strongly encrypted database with such a user identifying code, which user identifying code matches the user identifying code present in said intermediate means. The intermediate means may for example send a request to a strongly encrypted database for information by only supplying the database with said user identifying code (for example a social security number), whereby the database delivers the information, or at least some of the information, associated in the database with said code. Most preferably, the strongly encrypted database only supplies the intermediate means with user identifying code-related information present in the database, without delivering, however, a user identifying code or an internal identifier. Most preferably, said database does not even have knowledge regarding said internal identifier.

After this, some of said strongly encrypted database information delivered to the intermediate means is conveyed therefrom to the health card, whose internal user identifier has said user identifying code associated therewith by means of said intermediate means. This method provides a capability of using strong encryption or authentication requiring personal information of a user for example in connection with said health card in such a way that the access thereto can be allowed with weak authentication, or that such information can be at least to some extent visible also for others, for example for members of one specific group in need of motivation, yet in such a way that the strong encryption or authentication requiring information is not associable with the user's true identity but, for example, only with the user's pseudonym or anonymous identifier (i.e. the intra-health card user identifier).

According to one embodiment of the invention, the intermediate means destroys said intermediate means-delivered information supplied from a strongly encrypted database after at least some of said information has been conveyed to the health card. This makes it possible to minimize possible wrongdoings at later stages.

Further according to one embodiment of the invention, the health card can be in data transfer communication also with a party other than the party with a strongly encrypted database. Such a database can be for example a motivation group or the like, wherein the user can be motivated for his/her achievement, for example for losing weight, by the comparison of said information or activities based on that. In this case, the health card may deliver information between said health card and said other party most preferably in such a way that the information is associable at said parties by means of an internal identifier (for example #Peter72). This way the user can also be given stimuli, incentives, feedbacks, etc.

According to one embodiment of the invention, the health card information can be used as a basis for producing a transmission, on the basis of which some party, for example a laboratory, then conducts procedures and conveys the results of such procedures to a database in a manner associable with a user identifying code. The user identifying code must naturally be produced in the transmission at some point, for example as an addition made by the user him-/herself or by a third party. After this, at least some of the results of the procedures can be delivered by way of an intermediate means to the health card. Either the health card conducts a request for or the third party's database sends the result to the health card after identifying the same by means of an identifier.

Still further, according to one embodiment of the invention, the intermediate means upholds log information in a service with a strong authentication requiring as regards data transfer, such that such information is not associable with information of the strongly encrypted database. The log information can be used to confirm afterwards i.a. that the data transfer has occurred and has occurred correctly.

The invention offers distinct advantages over what has been known before. Inter alia, the invention enables a secure data transfer between parties with different authentication demands, such that information which in itself requires strong authentication can be at least to some extent presented under anonymous identifiers in such a way that the true identity of a user is not revealed or even cannot be discovered. In addition, the invention also enables the presentation of information with a weak authentication requiring along with information that requires strong authentication.

### DESCRIPTION OF THE FIGURE

Preferred embodiments of the invention will be described in the next section slightly more precisely with reference to the accompanying figure, in which

FIG. 1 shows one exemplary method according to one preferred embodiment of the invention.

### DETAILED DESCRIPTION OF THE FIGURE

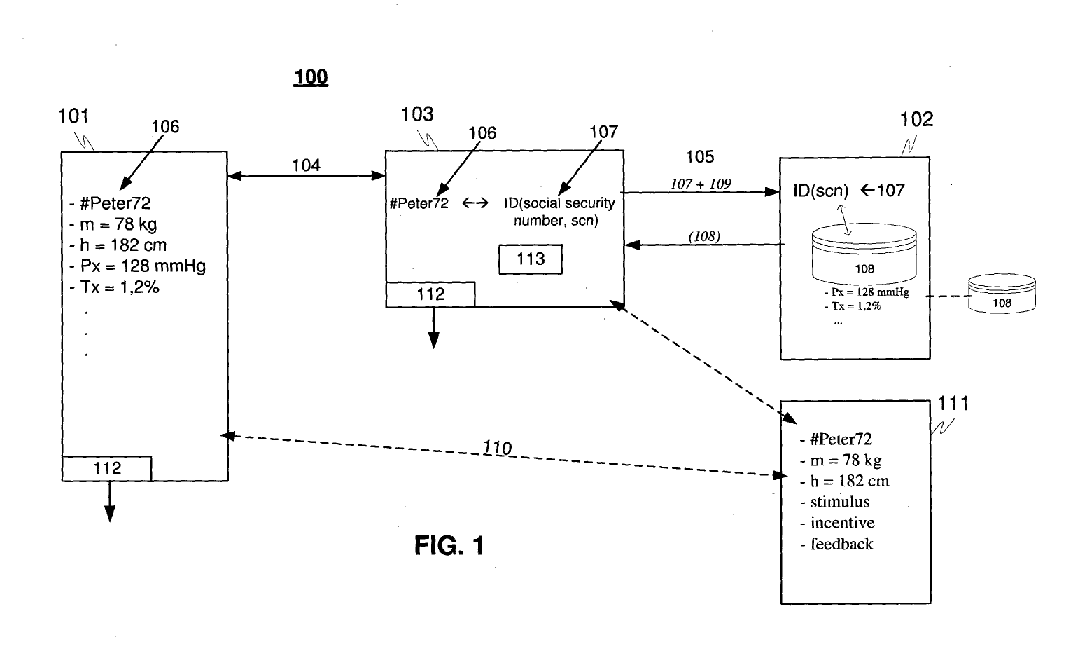

FIG. 1 shows one exemplary arrangement 100 according to one preferred embodiment of the invention for managing a health card 101 and health card-related communications between at least two parties, namely a health card user (technically a health record) 101 and a party 102 that most preferably requires strong authentication. The party with a strong authentication requiring can be for example a laboratory, which conducts i.a. laboratory tests on the health card user as in the example depicted in FIG. 1.

Between the health card 101 and at least one other party is provided an intermediate means 103, which is in a data transfer communication 104, 105 both with said health card 101 and the at least one other party, for example with a database 102 that requires strong authentication.

To enable the (weak) identification of a user, the health card 101 is furnished with an intra-health card user identifier 104, which can be for example an anonymous identifier such as #Peter72. For the intermediate means 103, on the other hand, the user is identified with some strong authentication method, such as for example by means of an online identification and payment service (VETUMA). During the course of identification, the intermediate means 103 is also supplied with information about the intra-health card user identifier (e.g. #Peter72), whereby, after a successful identification, the intermediate means 103 associates with each other said intra-health card user identifier 106 and a user identifying code (e.g. social security number) 107 supplied in connection with strong identification. The association takes place in the intermediate means for example by linking to each other an anonymous identifier used by the user in his/her health card and the user's social security number.

Once the linking is completed in the intermediate means, the system is ready for data transfer between different parties. According to one example, for example a laboratory produces strong authentication requiring information (#128 mmHg, #0,52%, #2,3 . . . ) 108 for its database 102. The producer of said information also provides its database with a user identifying code 107, such that said information that requires strong authentication is associable with said identifying code. Hence, the intermediate means 103 may send a request 105 to the strong authentication requiring database 102 for strong authentication requiring information (such as laboratory results) for example by supplying the party 102 with the user identifying code 107, whereby the party 102 respectively in response supplies the intermediate means 103 with the strong authentication requiring information associated with this particular user identifying code.

It should be noted that the party 102 most preferably only supplies the intermediate means 103 with the user identifying code-related information present in the database without, however, delivering the user identifying code or the internal identifier. In addition, according to one embodiment, the intermediate means 103 in connection with the request supplies the party 102 not only with the user identifying code 107 but also with a request identifying code 109, whereby the party 102, while responding, may deliver user-related strong authentication requiring information as well as the request identifying code 109, the intermediate means being thereby capable of associating a response supplied by the party with a request relating to the proper user, especially in the case that the intermediate means serves a plurality of different users or health file copies.

After receiving a response, the intermediate means 103 is adapted to deliver at least some of the strong authentication requiring information 108 supplied by the party 102 to such a health card 101 and identifier 106, said health card having its internal identifier 106 matched by said user identifying code 107 in the intermediate means 103. The intermediate means can be adapted to destroy said information supplied by the party 102 after at least some of said information has been delivered to the health card.

According to one embodiment of the invention, the health card 101 can also have a data transfer communication 110 with some third party 111, wherein the third party does not require strong authentication. Such a party 111 can be for example a motivation group or the like, in which the users can be motivated for their achievement, for example losing weight, by comparing said information or actions based on the same. Hence, the health card may deliver 110 information between said health card and said third party for example in such a way that the information is associable at said parties by means of an internal identifier (for example #Peter72). Thereby, the user (or the user's health file copy 101) can also be given for example stimuli, incentives, feedbacks, etc. It is also possible that the health card/file copy 101 be in communication with third parties by way of the intermediate means 103, but it is obvious that, in such contexts of low authentication demanding, there is no delivery of a user identifying code (for example social security number).

The health card or file copy 101 is adapted to present both at least some of the strong authentication requiring information supplied thereto (from the party 102) and also some of the lower authentication requiring information (from the party 111) in such a way that those sets of information are not associable with the user's true identity, such as for example with his/her social security number. This is made possible by not authenticating at any point a user for the health card or file copy 101 or by not even supplying user identifying information in any shape or form. Indeed, the health card or file copy 101 presents the information only in relation to said internal identifier or for example the user's anonymous identifier, on the basis of which alone the user's true identity cannot be found out.

In addition, the system can be adapted to produce, on the basis of the health card/file copy information, a transmission 112 for the user, which serves as a basis for some party, for example the laboratory 102, to conduct procedures and to deliver results of the procedures to a database in a manner associable with the user's identifying code. The transmission can be produced either by the health file copy (without a user identifying code) or by the intermediate means (in which case the transmission can be provided with a user identifying code).

The intermediate means can also be provided with means 113 for upholding log information relating for example to data transfer in a service that requires strong authentication. The log information is adapted to be upheld in a manner not associable with the information that requires strong authentication. The log information comprises at least a sort of data (such as time stamps and transmission addresses), which makes it possible to confirm afterwards i.a. that the data transfer has occurred and has occurred correctly.

Still further, according to one example, it is also possible that the intermediate means 103 may serve a plurality of health file copies 101a, 101b, 101c for various users and function as an intermediate means between said health file copies and other second parties. Said second parties may even be at least to some extent common for said health file copies. In this case, however, every health file copy (or the user's health card) must have an identifier personalizing the health file copy (card), e.g. healthcard#101a, healthcard#101b, etc., whereby the intermediate means is able to associate a given user identifying code (e.g. social security number) exactly with the intra-health card user identifier (e.g.. healthcard#101a-#Peter72 20101972-302P) of this particular user.

What have been described above are just a few embodiments for a solution of the invention. The principle according to the invention can naturally be varied within the scope of protection defined by the claims, regarding for example implementation details as well as fields of use. It should be appreciated that the electronic “health card”, i.e. the electronic health file copy, can be regarded as an electronic information entity, which is managed and organized according to the invention from information relating to a user and produced by various parties, and wherein said information provided in a health file copy is arranged to be accessible for various parties by means of methods and equipment of the invention.

It should further be appreciated that, although the intermediate means 103 is shown in the figure as a separate instrument between the parties, the intermediate means may also constitute a part of a health card or health file copy according to the invention, whereby, according to one example, the health card or file copy designated for each user also comprises its own intermediate means or at least its functionality. In this case, it should be noted that the health card or file copy is nevertheless divided, as regards its information content, into at least two segments, such that a public segment or a low authentication requiring segment of the health file copy is in terms of its information content separate from the information content of the intermediate means, thus eliminating the possibility of the user's true identity becoming public.

1-11. (canceled)

12. A method for managing an electronic health card and health card-related communications between at least two parties, the method comprises providing an electronic health card and furnishing it with an intra-health card user identifier, for example with an anonymous identifier,
providing between the health card and at least one party, which requires strong authentication, an intermediate means which is in data transfer communication with both said health card and said party,
supplying the intermediate means with information about the intra-health card user identifier and identifying a user for the intermediate means with some strong identification, whereby, after a successful identification, the intermediate means is adapted to associate with each other said intra-health card user identifier and a user identifying code delivered in connection with strong identification,
providing, by the action of the at least one party, a strong authentication requiring database with information, which information is associable in said database with said user identifying code, and
supplying the intermediate means with information from said strong authentication requiring database, which information is associable in said database with such a user identifying code, which user identifying code matches with the user identifying code present in said intermediate means, and
supplying the health card from the intermediate means with at least some of said information of the strong authentication requiring database delivered thereto, the internal user identifier (106) of said health card having associated therewith said user identifying code by said intermediate means.

13. A method as set forth in claim 12, wherein said intermediate means destroys from the intermediate means said information supplied from a strong authentication requiring database after at least some of said information has been delivered to the health card.

14. A method as set forth in claim 12, wherein the intermediate means sends a request to a strong authentication requiring database for information by supplying said database only with said user identifying code.

15. A method as set forth in claim 12, wherein the strong authentication requiring database only supplies the intermediate means with information present in the database and relating to a user identifying code, without delivering, however, the user identifying code or the internal identifier.

16. A method as set forth in claim 12, wherein the health card is in data transfer communication with some party other than the strong authentication requiring party, whereby information is communicated between said health card and said other party in such a way that the information is associable at said parties by means of the internal identifier.

17. A method as set forth in claim 12, wherein the health card information is used as a basis for producing a transmission, and wherein some party, for example a laboratory, conducts procedures on the basis of said transmission and communicates results of the procedures to the database in a manner associable with a user identifying code.

18. A method as set forth in claim 17, wherein at least some of the results of the procedures are delivered by way of the intermediate means to the health card.

19. A method as set forth in claim 12, wherein the intermediate means upholds log information relating to data transfer, such that such information is not associable with the strongly encrypted database information.

20. A system for managing an electronic health card and health card-related communications between at least two parties, wherein
the system is adapted to provide an electronic health card and to furnish it with an intra-health card user identifier, for example an anonymous identifier,
the system comprises an intermediate means, which is arranged between the health card and at least one party with a strong authentication requiring, and which is in data transfer communication both with said health card and with the party that requires strong authentication,
the intermediate device is adapted to receive information about the intra-health card user identifier, to identify a user with some strong identification, and to associate with each other said intra-health card user identifier and a user identifying code delivered in connection with strong identification,
the system is adapted to provide, by the action of at least one party, the strong authentication requiring database with information, said information being associable in said database with said user identifying code,
the system is adapted to supply the intermediate means with information from said strong authentication requiring database, which information is associable in said strong authentication requiring database with such a user identifying code, which user identifying code matches with the user identifying code present in said intermediate means, and
the system is adapted to supply the health card from the intermediate means with at least some of said information of the strong authentication requiring database delivered thereto, the internal user identifier of said health card having associated therewith said user identifying code by said intermediate means.

21. A system as set forth in claim 20, wherein the strong authentication requiring database is adapted to supply the intermediate means only with information relating to the user identifying code present in the database, without delivering, however, the user identifying code or the internal identifier.

22. A system as set forth in claim 20, wherein the health card is set in data transfer communication also with some party other than the strong authentication requiring party, whereby information is communicated between said health card and said other party in such a way that the information is associable at said parties by means of the internal identifier.
